(19) United States
(12) Patent Application Publication
(10) Pub. No.: US 2004/0069852 A1
(43) Pub. Date: Apr. 15, 2004

(54) Bluetooth RF based RF-tag read/write station

(75) Inventors: Pauli Seppinen, Espoo (FI); Aarno Parssinen, Espoo (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/606,284

(22) Filed: Jun. 25, 2003

Related U.S. Application Data
(60) Provisional application No. 60/392,732, filed on Jun. 26, 2002.

(51) Int. Cl. G01S 1/08; G06K 7/08

(52) U.S. Cl. 235/451; 342/386

(57) ABSTRACT

A transceiver is provided that can adapt itself to operate as an RF tag reader or as a bluetooth transceiver by changing its reception and transmission capabilities. The cost and area of an additional transceiver where both a bluetooth transceiver and an RF tag reader are required is avoided. The same radio part is used for both bluetooth and for RF tag reader operation. Since the operation band is the same, there is no need to change the center frequency of the resonance needed by the radio front-end. Software controlled adaptivity is included due to the different nature of these systems so that the mode of the radio hardware can be programmed easily and on the fly. This provides a software defined architecture tailored for bluetooth/RF tag operation. This invention integrates two different systems to one transceiver chip giving cost and space savings by reusing existing analog parts.

### CROSS-REFERENCE TO RELATED APPLICATION

This regular U.S. patent application claims priority from U.S. Provisional Application Serial No. 60/392,732, filed Jun. 26, 2002.

### BACKGROUND OF THE INVENTION

1. Technical Field

This invention is related to short range communication technology. Furthermore, the invention is related to a mobile terminal or a device using an additional radio for short-range communication.

2. Discussion of Related Art

The bluetooth wireless technology revolutionizes the personal connectivity market by providing freedom from wired connections—enabling links between mobile computers, mobile phones, portable hand-held devices, and connectivity to the Internet. Bluetooth devices operate at 2.4 GHz in the globally available, license-free ISM (industrial, scientific and medical) band. In a bluetooth system, the operating band is spaced into one megahertz channels, each signalling data at one megasymbol per second so as to obtain a maximum available channel bandwidth. GFSK (Gaussian frequency shift keying) is chosen as the modulation scheme with a binary one giving rise to a positive frequency deviation from the nominal carrier frequency and a binary zero giving a negative frequency deviation. After each packet, the devices in communication with each other retune their radio to a different frequency, effectively hopping from radio channel to radio channel (frequency hopping spread spectrum (FHSS)). By means of the frequency hopping technique the entire band is utilized so that interference in one channel will not cause the entire communication to be prevented. Each time slot lasts 625 microseconds and devices will hop once per packet, which will be every slot, every three slots or every five slots. Due to the intended use for low-powered portable applications, the radio power must be minimized within one of three different classes with powers of 1 mW (10 dBm), 2.5 mW (4 dBm), and 100 mW (20 dBm), with respective operation ranges of 10, 20 and 100 meters.

Bluetooth radio system architectures can take various forms. Such would include for instance zero IF (intermediate frequency) or direct conversion, heterodyne or single bit modulation, multi-bit IQ sample modulation using look-up tables, and even direct transmit modulation on to a transmit synthesizer.

On the other hand, RFID (radio frequency identification) systems are simpler than bluetooth systems but can be used for a variety of different applications, for instance in the field of item management, identification, payment, electrical signature and so on. In the future, these RF tags can also be deployed everywhere. The need of reading and writing to such devices is increasing and means for doing these operations are needed. The RFID system operates in the 2.4 GHz ISM Band as well.

In the simplest RFID systems, the reader both powers and communicates with the tags that are within a certain range. During the powering phase the reader sends constant RF power to the tag, which loads a charging capacitor in the tag using a resonator operating as an antenna. When the charging capacitor is loaded, the tag can operate as a radio, receiving and transmitting data. During the time when a passive tag is communicating back to the reader, the reader transmits a steady radio power, and the tag modulates the impedance of its antenna. The reader receives the data as a variation of the reflected signal or as a variation of the antenna impedance. A passive backscatter RFID system uses this kind of radio interface. In its simplest form, the passive RFID system uses on-off keying (OOK) as the modulation technique, but also FSK, PSK and other modulation techniques may be used. RFID systems are operating at multiple frequency bands.

At the present time it is necessary, depending on whether the intended use is bluetooth or an RFID application, to use two different transceivers that have been designed for the given system, bluetooth or RFID. It would be advantageous to be able to use a single transceiver for either purpose. Moreover, a problem with RFID readers or interrogators is that the information is gathered locally but may be more useful in another location, such as a remote analysis center.

### DISCLOSURE OF INVENTION

An object of the present invention is to provide a transceiver that can adapt itself to operate as an RF tag reader or as a bluetooth transceiver by changing its reception and transmission capabilities.

Another object of the invention is to make it possible to avoid the extra cost and area of an additional transceiver where both a bluetooth transceiver and an RF tag reader are required.

Yet another object of the invention is to make it possible to use a mobile device as both a bluetooth transceiver and an RF tag reader.

A further object is to make information gathered locally by an RFIC reader or interrogator or by a bluetooth device, or both, available at another location.

According to a first aspect of the present invention, a transceiver adapts itself to operate as an RF tag reader or as a bluetooth transceiver by changing its reception and transmission capabilities.

Further according to the first aspect of the invention, the bluetooth transceiver is useable as a transceiver for a 2.4 GHz ISM band RF tag reader system.

Still further according to the first aspect of the invention, a single antenna is useable for the transceiver as the RF tag reader or as the bluetooth transceiver.

Further still according to the first aspect of the invention, the transceiver is in a mobile terminal.

According to a second aspect of the invention, a radio device having a radio receiver and a radio transmitter operates in two modes, a bluetooth mode and an RF tag reader mode.

Further according to the second aspect of the invention, the operability of the radio device in either mode uses the radio receiver and said radio transmitter.

Further still according to the second aspect of the invention, the radio device is in an incorporating device having additional device functionality.

Yet further still according to the second aspect of the invention, the incorporating device comprises a mobile telephone.

Further still according to the second aspect of the invention, the radio device is installed in a mobile telephone.

According to a third aspect of the invention, a radio device having a radio receiver, a radio transmitter, and a signal processor, wherein the radio receiver is responsive to an incoming analog radio signal for providing a down converted and modulated signal to the signal processor, and wherein the radio transmitter is responsive to in-phase and quadrature digital components of an output signal from the signal processor for transmission as an outgoing analog radio signal, is characterized by control logic for controlling the radio device in two modes, a first mode for operating as a bluetooth device and a second mode for operating as an RF tag reader.

The basic idea behind the first aspect of the invention is the possibility to use the same radio part as used for bluetooth for an RF tag reader as well. Since the operation band is the same, there is no need to change the center frequency of the resonance needed by the radio front-end. But, some adaptivity has to be included to the radio because of the different nature of these systems. In this case, adaptivity means that some adaptive architectural solutions have to be utilized. The adaptivity should be controlled by software so that the mode of the radio hardware can be programmed easily and on the fly. This concept can be called a software defined architecture tailored for bluetooth/RF tag operation.

Typically, bluetooth and RF tag readers are not integrated to a single chip or even into a single device. This invention integrates two different systems to one transceiver chip giving cost and space savings by reusing existing RF, analog, digital and mixed signal parts. Also, if the modulation is FSK, some of the DSP can be reused as well. By integrating these systems into a mobile device, different applications are enabled. These applications can be as follows: reading an RFID tag and sending this information directly to a database or using the data for the user's purpose, downloading money, usage time, tickets or equivalent to the RF tag from an internet page, WAP page or from some other service provider using all possible means of connectivity that are and will be implemented to a mobile device. These are just some examples. Several other applications can be possible.

This invention enables the use of a bluetooth RF chip as a transceiver for a 2.4 GHz ISM band RF tag reader system. The reuse decreases the price of the RF tag reader dramatically because no separate chip for each system is needed. Also, the antenna and PCB (printed circuit board) can be the same giving more cost savings. The invention according to the first aspect of the invention may be adapted to a mobile device, such as a mobile phone, or to some other type of device. A mobile phone user could select whether he/she wants to communicate with an RF tag or utilize a bluetooth connection. This invention targets as efficient a reuse of existing bluetooth RF parts as possible.

This invention is disclosed in the context of RFID systems operating at the 2.4 GHz band. The invention is nonetheless applicable to other RFID systems and several such others are considered briefly to show the wide scope of the invention and not by way of limitation.

In this invention, the RF tag can be a passive, semi passive or an active device. A passive RF tag is powered by the reader RF power, a semi passive tag is awakened by the reader RF power, but the actual DC power is from a battery, and an active tag is completely powered by the tag's own power source.

According to a second aspect of the present invention, a mobile device such as a mobile telephone may be used as either a bluetooth transceiver or an RFID tag reader. This makes the mobile device more versatile and useful since it can perform functions in both the bluetooth context, the RFID tag reader context, or both. The use of a mobile device such as mobile telephone with both bluetooth and RF tag reader capabilities as well as normal mobile telephone capabilities according to known standards potentially makes the device exceedingly powerful for an increasingly wide variety of purposes including scientific, military, industrial, civilian governmental functions, etc. For instance, in an RF tag reader function, the mobile device can interrogate and read the response from an RFID tag and use its mobile telephone data communications capabilities to transmit the information read from the RFID tag to a remote location where the information may be utilized. Similarly, the mobile telephone data capabilities can be used to report to a remote data collection site the information collected by means of the bluetooth capabilities of the mobile device in communication with a multitude of nearby bluetooth capable devices.

These and other objects, features and advantages of the present invention will become more apparent in light of the detailed description of a best mode embodiment thereof, as illustrated in the accompanying drawings.

### BRIEF DESCRIPTION OF THE DRAWING

FIG. 1 shows one possible bluetooth/RF tag reader transceiver topology. This topology is but one example and various other solutions are possible given the teachings hereof. This solution is based on a low-IF concept at the RX side and the TX side and it can fulfill specifications for both systems.

FIG. 2 shows a bluetooth/RF tag reader, such as that of FIG. 1 deployed in various devices.

Best Mode for Carrying Out the Invention Abbreviations

| | |
|---|---|
| A/D | analog-to-digital converter (also called ADC) |
| AM | amplitude modulation |
| ASIC | application specific integrated circuit |
| BB | baseband |
| CPU | central processing unit |
| D/A | digital-to-analog converter (also called DAC) |
| DSP | digital signal processing |
| FDD | frequency division duplexing |
| FM | frequency modulation |
| FSK | Frequency Shift Keying |
| GFSK | Gaussian FSK |
| IC | integrated circuit |
| IF | intermediate frequency |
| ISM | Industrial, Scientific Medical |
| LNA | low noise amplifier |
| LO | local oscillator |
| PA | power amplifier |
| PM | phase modulation |
| RX | receiver |
| RF | radio frequency |
| RSSI | received signal strength indicator |
| TX | transmitter |
| TDD | time division duplexing |
| VCO | voltage controlled oscillator |

Bluetooth is a short-range radio system that operates at 2.4 GHz ISM band (2403-2480 MHz). It is a fast frequency hopping spread spectrum system with a 1 Mbit/s data rate and a 1 MHz bandwidth for −20 dBc. It has 83 channels and the channel spacing is 1 MHz. The modulation is GFSK with a modulation index from 0.28 to 0.35. Output power in the power class 2 (20 m) can be between −6 and 4 dBm. Nominal output power is 0 dBm. Class 1 is designed for 100 meters and allows for 100 milliwatts (20 dBm) while Class 3 is only allowed 1 milliwatt (0 dBM) for a range of 10 meters.

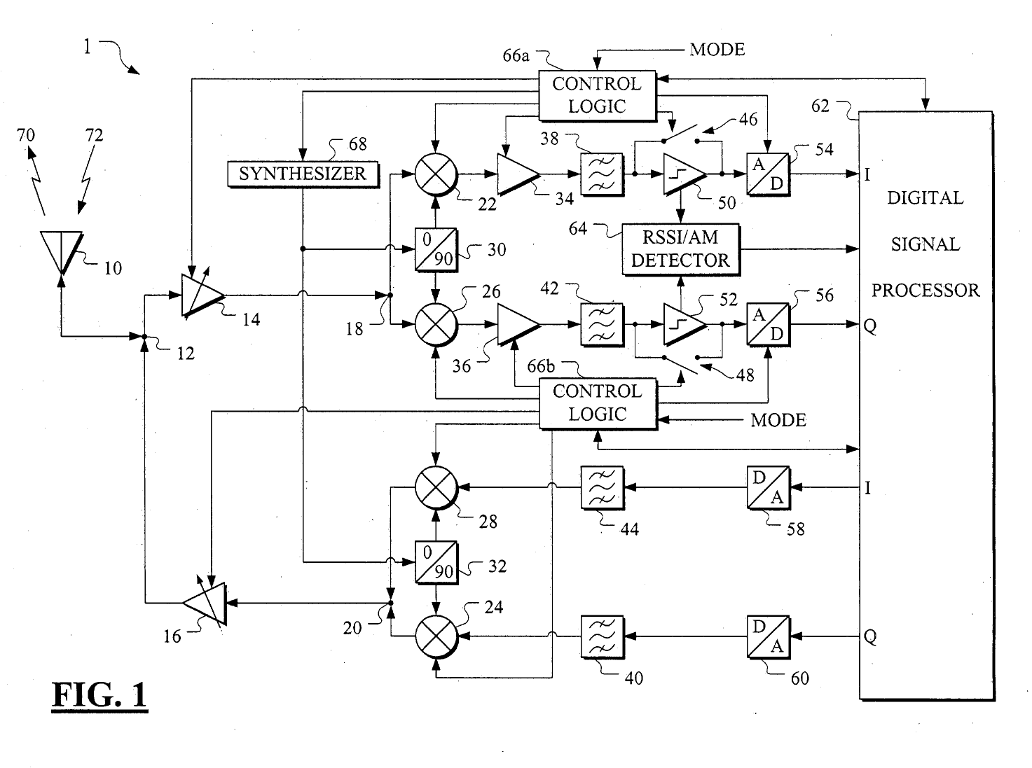

This disclosure concentrates on combining a bluetooth transceiver with the simplest RF tag based on standards specifying operation in the 2.4 GHz ISM band. These systems are passive or semi-passive RF tag systems. One possible standard is, for example, ISO/IIEC 18000-4 model. But it should be realized that the invention is not restricted thereto or to the particular example shown. FIG. 1 shows a dual mode bluetooth/RF tag reader transceiver topology. This topology is one example, but it should be realized that various other solutions exist. Especially, it is common to use a fractional N synthesizer to directly modulate the VCO in a bluetooth transmitter. The transceiver architecture shown in this invention can fulfill radio specifications for both the bluetooth and RFID systems. The signal flow and the states of the building blocks are conventional when this transceiver is used in the bluetooth mode. By using this topology, the TX could operate in direct up-conversion or low-IF mode. Bluetooth is a TDD system and thus the RX part (shown in upper half) and TX part (in lower half) are not operating at the same time. Typically, a switch separates TX and RX in TDD systems, but also solutions exist where the LNA 14 and PA 16 are simply connected together. This is possible especially in systems like Bluetooth due to the small TX output power. The latter solution is used for this invention, as shown in FIG. 1. When this device is operating in the RFTAG reader mode the LNA 14 is operating as an attenuator attenuating the TX signal so that the receiver is able to receive the signal without compression. The gain and other receiver characteristics are controlled by the control logic 66a, 66b. The transmit amplifier 16 provides transmit power supply to the antenna 10 and the power level may also be controlled by the control logic 66. Additionally, a circulator or some other component can be utilized for separation of the forward and reflected signals. The amplitude modulation can be added to the TX signal in the analog or in the digital domain. The RX is here a low-IF receiver, but also other types such as direct conversion can be utilized, as mentioned previously. The difficulty when combining both bluetooth and RFID systems to one chip is that they use different modulation and that for an RF reader the TX signal is on during the reception, i.e., the TX signal is modulated in the reception by the RF tag. This means that TX and RX are on at the same time. This is not the case for bluetooth. Since the output power in the bluetooth radio is approximately 0 dBm, the modulated TX signal has to be attenuated in the reception phase in order not to compress the RX part totally. If the RF front-end is in deep saturation, the signal modulated by the RF tag is attenuated. This is why the LNA 14 has to be switched off so that the attenuation is adequate and so that the incoming signal can be demodulated. This can be done by the control logic 66a, 66b. The gain of the LNA can be reduced significantly also by the control logic or by other means. Any kind of signal attenuation technique can be used in this invention to prevent the compression. If some type of isolation is added, using for example a circulator, attenuation in the LNA is not needed and the receiver can be made more sensitive, resulting longer reading ranges.

As mentioned, in the simplest RFID systems the modulation can be OOK, which means simply switching the RF signal on and off. In the transmission the modulation can be done in the DSP 62, in analog baseband or in RF. In the reception phase, the signal, modulated by the RF tag, is attenuated, down converted, filtered and demodulated. One possible way of demodulation is the use of the RSSI block 64. The time constant of the RSSI block has to be small enough so that the RSSI can follow the signal. This means that the time constant has to be adaptive. If this type of AM demodulation is used, both analog-to-digital converters can be switched off by the control logic. One other way is to bypass some or all of the amplifiers in the limiter chain so that the signal is not limited. In that case, ADC can be used to digitize the signal and the DSP can handle the demodulation. The demodulator implemented in the DSP can be a typical AM demodulator or some other type of amplitude detecting block like RSSI. However, the required dynamic range for the ADC is large in this case. I and Q branches are not necessarily needed for demodulation, meaning that the other ADC and possibly both limiters can be switched off by the control logic. In the preferred mode of this embodiment the gain and bias current of the different RX blocks, like mixers, LNA and filters, can be tuned digitally or by analog means. This way, all the RX blocks can be used to define best possible dynamic range of the receiver in a similar manner than in a conventional gain control system but additionally effecting to the performance of each block as well. This adaptivity could be controlled by a control logic, as shown, which can handle the settings of the adaptive receiver. In the simplest case, the input to this control logic could be only one bit, which is selecting the mode.

The device 1 of FIG. 1 will now be described in detail, starting with the receive portion in the upper half of the diagram, the receive low noise amplifier 14 has already been described. It provides an output signal to an RF power divider in supplying the RF signal to an I-inphase down conversion mixer 22 and to a Q-quadrature down conversion mixer 26. Both of these mixers 22, 26 may (but not necessarily) be controlled by the control logic, e.g., for dynamic range purposes. In the bluetooth mode, the mixers are fed frequency hopping signals by a synthesized local oscillator quadrature phase shifter 30 creating I and Q local oscillator signals. These signals from the phase shifter 30 are used to drive the down converter mixers 22, 26. The synthesizer 68 is under the control of the control logic for purposes of providing the desired frequency hopping functionality. The received signals from the node 18 at the inputs of the mixers 22, 26 are mixed with the output signals from the quadrature phase shifter 30. The mixers provide output signals to respective I channel IF (intermediate frequency) amplifier 34 and receive Q channel IF amplifier 36. These IF amplifiers 34, 36 may be controlled by the control logic as well. It is noted that the control logic itself is controlled as to its mode by a mode select signal which determines whether the device 1 is operating in the bluetooth mode or the RF reader mode. The source of this signal may be from outside the circuitry of FIG. 1, for instance from within a device such as a mobile phone device within which the device of the figure is resident.

In any event, the outputs of the IF amplifiers 34, 36 are provided to respective I and Q receive I channel and Q channel IF filters 38, 42 which act as bandpass filters for removing unwanted mixer products. The bandpass filter outputs of the filters 38, 42 are provided to limiters 50, 52 which act as receive I channel IF limiter 50 and receive Q channel IF limiter 52. Although shown separately, the RSSI/AM detector 64 may in some cases be part of the limiters 50, 52. In any event, the limiters provide output signals to analog-to-digital converters 54, 56 for use (for instance in the bluetooth mode) for converting an analog I or Q received signal that has been phase modulated or frequency modulated to a digital signal for application to the I and Q inputs of the DSP 62.

In the case of an amplitude modulated signal such as would be received in an RF tag reader mode, the limiter functions 50, 52 would not be used and would be shorted out by switches 46, 48 under the control of the control logic. The incoming I and Q branches would be fed to the RSSI/AM detector 64 for purposes of AM detection. The output of the AM detector 64 is provided to the DSP as shown. Or, as previously discussed, the AM could be detected in the DSP via the ADCs 54, 56.

Focusing now on the lower half of FIG. 1, the transmission section will be described. The digital signal processor 62 provides I and Q output signals to digital-to-analog converters 58, 60 which in turn provide analog output signals to transmit I channel IF filter 44 and transmit Q channel IF filter 40. These filters 44, 40 provide output signals to respective I and Q channel IF to RF up converter mixers 28, 24. The mixers may also be under the control of the control logic for instance dynamic range purposes but this is not necessarily the case. In any event, the mixers are also responsive to input signals from a synthesized local oscillator quadrature phase shifters 32 that creates I and Q local oscillator signals to drive the up converter mixers 28, 24. These signals from the quadrature phase shifters 32 are mixed with the input signals to the mixers coming from the filters 44, 40 as shown. The synthesizer 68 provides an output signal under the control of the control logic to the synthesized local oscillator quadrature phase shifter 32 for the same reason as described above in connection with the receive section quadrature phase shifter 30.

The mixers 24, 28 provide output signals to a node 20 combining the I and Q transmit signals from the RF up converters 28, 24. The node 20 provides a combined output signal to the transmit amplifier 16 already discussed above which may be under the control of the control logic for purposes of controlling for instance its dynamic range. The output of the transmit amplifier 16 is provided to the node 12 which in turn provides a transmit output signal for transmission by the antenna 10 as an output radio signal 70 radiated from the antenna 10. Node 12 can be replaced with a circulator in order to increase the sensitivity of the reception.

The transceiver introduced in this disclosure is preferably implemented into a single IC chip, which is used in a bluetooth module.

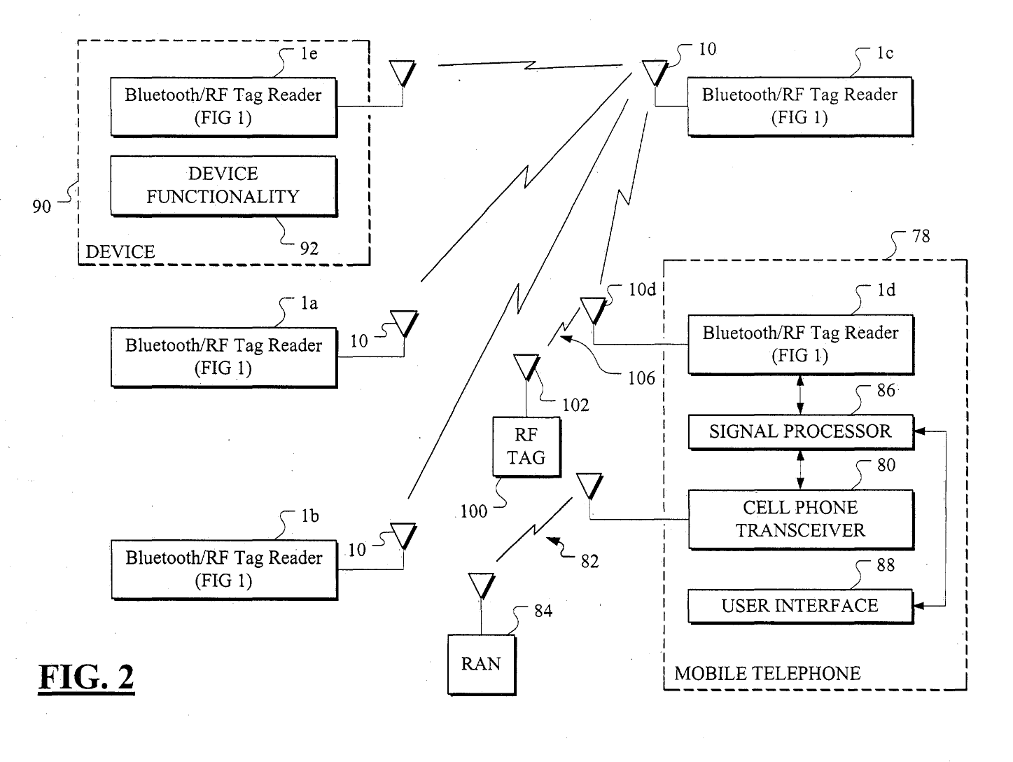

FIG. 2 shows a bluetooth/RF tag reader such as that shown in FIG. 1 deployed as a stand-alone device or as part of other devices in a generalized network, which may include some or all of the devices shown. As can be seen from FIG. 2, the bluetooth/RF tag reader of FIG. 1 can be employed as a stand-alone device, such as shown by the devices 1a, 1b and 1c of FIG. 2. These bluetooth RF tag readers are shown operating, for instance, in a bluetooth piconet made up of a bluetooth master 1c and slaves 1a, 1b. Such a piconet may also include other bluetooth/RF tag readers deployed within larger devices. For instance, a mobile telephone 78 is shown having a bluetooth/RF tag reader 1d that is also operating in the aforementioned bluetooth piconet as a slave to the master bluetooth device 1c. But the mobile telephone 78 also has a cell phone transceiver 80 that permits it to communicate as a mobile telephone so that the user can communicate by means of a radio interface 82 with a radio access network 84. The mobile telephone 78 will have a signal processor 86 that is in control of both the bluetooth/RF tag reader 1d and the cell phone transceiver 80, as well as a user interface 88.

Another device 90 is shown which may or may not be a mobile device. It also has a bluetooth RF tag reader 1e similar to that shown in FIG. 1 and in addition has other device functionality 92, which is shown generically in the figure. The bluetooth/RF tag reader 1e is shown operating as a slave to the master bluetooth device 1c in the aforementioned bluetooth piconet.

Also shown in FIG. 2 is an RF tag 100 that is capable of being interrogated by any of the RF tag readers 1a, 1b, 1c, 1d, 1e of FIG. 2. Thus, the bluetooth/RF tag reader 1d may be switched into RF tag reader mode by the signal processor 86 in accordance with the principles described above (in connection with FIG. 1) and interrogate the RF tag 100 over a bidirectional radio interface 106 between an antenna 10d of the RF tag reader 1d and the antenna 102 of the RF tag 100. Likewise, any of the other bluetooth/RF tag readers 1a, 1b, 1c, 1e of FIG. 2 can switch to the RF tag reader mode and interrogate the RF tag 100 and receive a response back therefrom with data contained in the RF tag 100. In the case of the mobile telephone 78, this is particularly advantageous because the data from the RF tag can be retrieved by the RF tag reader Id and transferred to the signal processor 86. The signal processor 86 can then either present the retrieved information to the user via the user interface 88 or send it to a remote location using the cell phone transceiver 80 and an air interface 82 to a radio access network 84, or both. This makes a mobile telephone a very versatile device having both cell phone functionality, bluetooth functionality and RF tag reader functionality. It should be realized that, for purposes of this aspect of the invention, the bluetooth/RF tag reader 1d could be separate devices, unlike the shared radio functionality shown in FIG. 1. In other words, a separate bluetooth transceiver and a separate RF tag reader transceiver would be used in combination with the cell phone transceiver, signal processor and user interface if convenient or necessary.

Although the invention has been shown and described with respect to a best mode embodiment thereof, it should be understood by those skilled in the art that the foregoing and various other changes, omissions and additions in the form and detail thereof may be made therein without departing from the spirit and scope of the invention.

1. Transceiver that adapts itself to operate as an RF tag reader or as a bluetooth transceiver by changing its reception and transmission capabilities.

2. The transceiver of claim 1, wherein said bluetooth transceiver is useable as a transceiver for a 2.4 GHz ISM band RF tag reader system.

3. The transceiver of claim 2, wherein a single antenna is useable for said transceiver as said RF tag reader or as said bluetooth transceiver.

4. The transceiver of claim 1 in a mobile terminal.

5. Radio device having a radio receiver and a radio transmitter characterized by operability of said device in two modes, a bluetooth mode and an RF tag reader mode.

6. The radio device of claim 5, further characterized by said operability of said radio device in either mode using said radio receiver and said radio transmitter.

7. The radio device of claim 5, further characterized by said radio device in an incorporating device (90) having additional device functionality (92).

8. The radio device of claim 7, characterized by said incorporating device comprising a mobile telephone.

9. The radio device of claim 5, further characterized by said radio device installed in a mobile telephone (78).

10. Radio device having a radio receiver, a radio transmitter, and a signal processor (62), wherein the radio receiver is responsive to an incoming analog radio signal (72) for providing a down converted and modulated signal to said signal processor, wherein the radio transmitter is responsive to an output signal from said signal processor for transmission as an outgoing analog radio signal (70), characterized by control logic (66) for controlling said radio device in two modes, a first mode for operating as a bluetooth device and a second mode for operating as an RF tag reader.
